(19) United States
(12) Patent Application Publication
(10) Pub. No.: US 2013/0272267 A1
(43) Pub. Date: Oct. 17, 2013

(54) MOBILE COMMUNICATION METHOD, SUBSCRIBER MANAGEMENT SERVER, AND SERVER

(71) Applicants: Katsutoshi Nishida, Chiyoda-ku (JP); Hironori Chikura, Chiyoda-ku (JP); Takashi Morita, Chiyoda-ku (JP); Kazuhito Tokunaga, Chiyoda-ku (JP)

(72) Inventors: Katsutoshi Nishida, Chiyoda-ku (JP); Hironori Chikura, Chiyoda-ku (JP); Takashi Morita, Chiyoda-ku (JP); Kazuhito Tokunaga, Chiyoda-ku (JP)

(73) Assignee: NTT DOCOMO, INC., Tokyo (JP)

(21) Appl. No.: 13/883,090

(22) PCT Filed: Nov. 2, 2011
(86) PCT No.: PCT/JP2011/075327

§ 371 Date: Jun. 28, 2013

(30) Foreign Application Priority Data
Nov. 5, 2010 (JP) 2010-249193
Feb. 8, 2011 (JP) 2011-025290

(51) Int. Cl. H04W 36/00

(52) U.S. Cl. CPC H04W 36/0005
USPC 370/331

(57) ABSTRACT

A mobile communication method according to the present invention includes a step A of causing an SCC-AS to transmit an inquiry signal to an HSS when the SCC-AS receives “Invite” addressed to a UE; a step B of causing the HSS to transmit a paging request signal; a step C of causing the HSS to determine a RAT which the UE is served in response to a paging result notification signal including a paging result in at least one of an UTRAN/GERAN and an E-UTRAN; a step D of causing the HSS to transmit serving area information of the UE including information on the RAT which the UE is served to the SCC-AS/S-CSCF; and a step E of causing the SCC-AS/S-CSCF to transfer the “Invite” addressed to the UE, to the UTRAN/GERAN or the E-UTRAN using a terminating call scheme selected based on the serving area information of the UE.

### TECHNICAL FIELD

The present invention relates to a mobile communication method, a subscriber management server, and a server.

### BACKGROUND ART

TS23.292 of 3GPP specifies “T-ADS (Terminating Access Domain Selection)” function to determine upon receipt of a voice call whether to receive the voice call, at PS (Packet Switch) domain to provide “VoIP (Voice over IP) service or at CS (Circuit Switch) domain.

With reference to FIG. 6, processing upon receipt of such a voice call when using the T-ADS function will be described.

As shown in FIG. 6, when receiving “Invite”, which is a terminating call signal for voice communications addressed to a UE (User Equipment, mobile station), via an S-CSCF (Serving Call Session Control Function) in Step S2001, an SCC-AS (Service Centralization and Continuity-Application Server) transmits an inquiry signal for inquiring about a RAT (Radio Access Technology, a radio access network) to which the UE accessed last time, to an HSS (Home Subscriber Server, a subscriber management server) in Step S2002.

In Step S2003, the HSS transmits an access time inquiry signal for inquiring about the last access time by the UE to an SGSN (Serving GPRS Support Node, a packet switch)/MME (Mobility Management Entity, a mobility management node).

In Step S2004, the SGSN/MME transmits an access time notification signal for notifying the last access time by the UE to the HSS.

In Step S2005, based on the last access time by the UE in the SGSN/MME, the HSS identifies a RAT to which the UE accessed last time, specifically, a current RAT for the UE. In Step S2006, the HSS transmits a response signal including information on the current RAT for the UE to the SCC-AS.

In Step S2007, based on the information on the current RAT for the UE, the SCC-AS selects a terminating call scheme. In Step 2008, the SCC-AS instructs the S-CSCF to transfer the “Invite” addressed to the UE, to a UTRAN (Universal Terrestrial Radio Access Network)/GERAN (GSM EDGE Radio Access Network) or an E-UTRAN (Evolved Universal Terrestrial Radio Access Network), with the terminating call scheme.

When instructed to transfer the “Invite” to the UTRAN/GERAN, the S-CSCF transmits “IAM” to the UE through an MGCF (Media Gateway Control Function) and an MSC (Mobile-service Switching Center, a circuit switch) in Step S2009.

On the other hand, when instructed to transfer the “Invite” to the E-UTRAN, the S-CSCF transmits the “Invite” to the UE through a P-CSCF (Proxy Call Session Control Function) and an S/P-GW (Serving/PDN-Gateway, a gateway device) in Step S2009.

### PRIOR ART DOCUMENT

### Non-Patent Document

Non-patent document 1: 3GPP TS23.292

### SUMMARY OF THE INVENTION

### Problems to be Solved by the Invention

However, the T-ADS function has a problem that when the current RAT for the UE changes after the SCC-AS receives the above-mentioned response signal from the HSS, a receiving domain cannot be selected correctly, thus causing delay in receiving a call or failure in receiving a call and the like.

The T-ADS function also has a problem that action to take when the SCC-AS cannot select a receiving domain correctly has not been specified.

The T-ADS function has another problem that the number of location registration signals increases because the function cannot operate “ISR (Idle Mode Signaling Reduction)”, which is a procedure to reduce location registration signals when the current RAT for the UE changes.

Hence, the present invention has been made in light of the problems described above, and an object of the present invention is to provide a mobile communication method, a subscriber management server, and a server which enable the SCC-AS to correctly select an arriving domain, while enabling simultaneous operation of the T-ADS function and the ISR.

### Means for Solving the Problems

A first characteristic of the present invention is a mobile communication method in a mobile communication system including a radio access network of a first communication scheme and a radio access network of a second communication scheme, the mobile communication method including: a step A of causing a predetermined server to transmit an inquiry signal to inquire about serving area information of a mobile station to a subscriber management server when the predetermined server receives a terminating call signal for voice communications addressed to the mobile station; a step B of causing the subscriber management server to transmit a paging request signal to request at least one of the radio access network of the first communication scheme and the radio access network of the second communication scheme to transmit a paging signal; a step C of causing the subscriber management server to determine a radio access network which the mobile station is served, in response to a paging result notification signal including a paging result in the radio access network of the first communication scheme and the radio access network of the second communication scheme; a step D of causing the subscriber management server to transmit the serving area information of the mobile station including information on the radio access network which the mobile station is served to the predetermined server; and a step E of causing the predetermined server to transfer the terminating call signal for voice communications addressed to the mobile station, to the radio access network of the first communication scheme or the radio access network of the second communication scheme, using a terminating call scheme selected based on the serving area information of the mobile station.

A second characteristic of the present invention is a subscriber management server to be used in a mobile communication system including a radio access network of a first communication scheme and a radio access network of a second communication scheme, the subscriber management server including: a paging request signal transmission unit configured to transmit a paging request signal for requesting at least one of the radio access network of the first communication scheme and the radio access network of the second communication scheme to transmit a paging request signal, in response to an inquiry signal received from a predetermined server; and a response signal transmission unit configured to transmit serving area information of a mobile station including information on a radio access network which the mobile station is served to the predetermined server, in response to a paging result notification signal including a paging result in the radio access network of the first communication scheme and the radio access network of the second communication scheme.

A third characteristic of the present invention is a server to be used in a mobile communication system including a radio access network of a first communication scheme and a radio access network of a second communication scheme, the server including: an inquiry signal transmission unit configured to transmit an inquiry signal to inquire about serving area information of a mobile station to a subscriber management server when receiving a terminating call signal for voice communications addressed to the mobile station; a response signal reception unit configured to receive from the subscriber management server the serving area information of the mobile station including information on a radio access network which the mobile station is served; and a terminating call signal transmission unit configured to transfer the terminating call signal for voice communications addressed to the mobile station to the radio access network of the first communication scheme or the radio access network of the second communication scheme using a terminating call scheme selected based on the serving area information of the mobile station.

### Effects of the Invention

As described above, according to the present invention, a mobile communication method for causing an SCC-AS to correctly select a receiving domain while enabling T-ADS function and ISR to run simultaneously, a subscriber management server, and a server.

### BRIEF DESCRIPTION OF DRAWINGS

FIG. 1 is a view for illustrating overall configuration and operation of a mobile communication system according to a first embodiment of the present invention.

FIG. 2 is a functional block diagram of an SCC-AS according to the first embodiment of the present invention.

FIG. 3 is a functional block diagram of an HSS according to the first embodiment of the present invention.

FIG. 4 is a view for illustrating operation of a mobile communication system according to a modification 1 of the present invention.

FIG. 5 is a flow chart showing operation of the HSS according to the modification 1 of the present invention.

FIG. 6 is a view for illustrating overall configuration and operation of a conventional mobile communication system.

### MODE FOR CARRYING OUT THE INVENTION

### (Mobile Communication System According to a First Embodiment of the Present Invention)

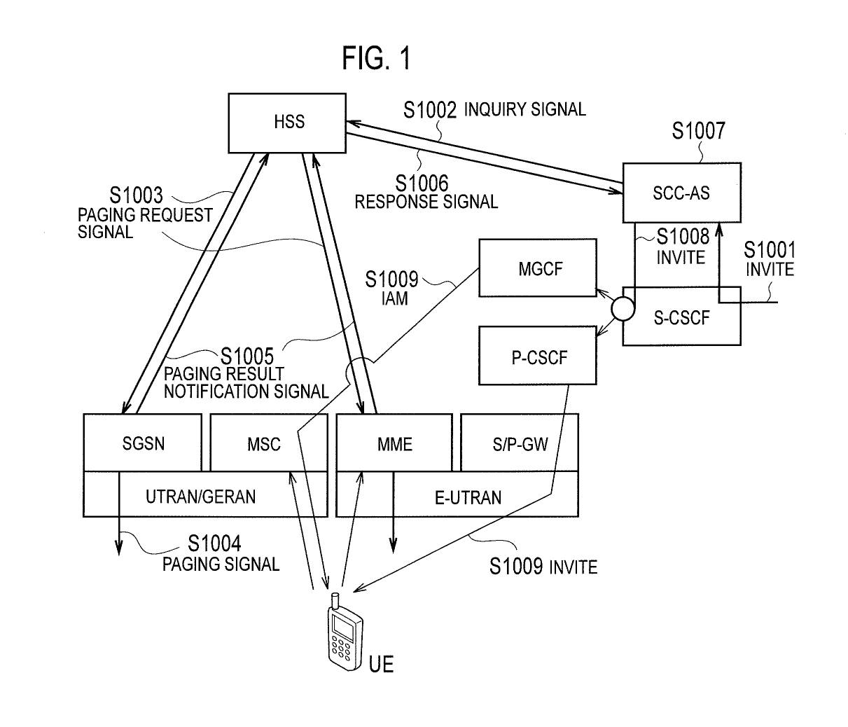

A mobile communication system according to a first embodiment of the present invention will be described with reference to FIG. 1 to FIG. 3.

As shown in FIG. 1, a mobile communication system according to the embodiment includes a UTRAN/GERAN and an E-UTRAN. Note that an RNC (Radio Network Controller) and a NodeB are provided in the UTRAN/GERAN and that an eNB is provided in the E-UTRAN.

In addition, the mobile communication system according to the embodiment includes an HSS, an SGSN, an MSC, an MME, an S/P-GW, an SCC-AS, an S-CSCF, an MGCF, a P-CSCF and the like.

Here, on a path among the SCC-AS, S-CSCF, P-CSCF, and S/P-GW, only U-plane data (user data) can be transferred and C-plane data (control signals) cannot be transferred.

Specifically, through the path, while the SCC-AS can transmit the U-plane data such as “Invite (a terminating call signal for voice communications)” addressed to a UE and the like to the S/P-GW, it cannot transfer the C-plane data such as a paging request signal to request the UTRAN/GERAN and the E-UTRAN to transmit a paging signal.

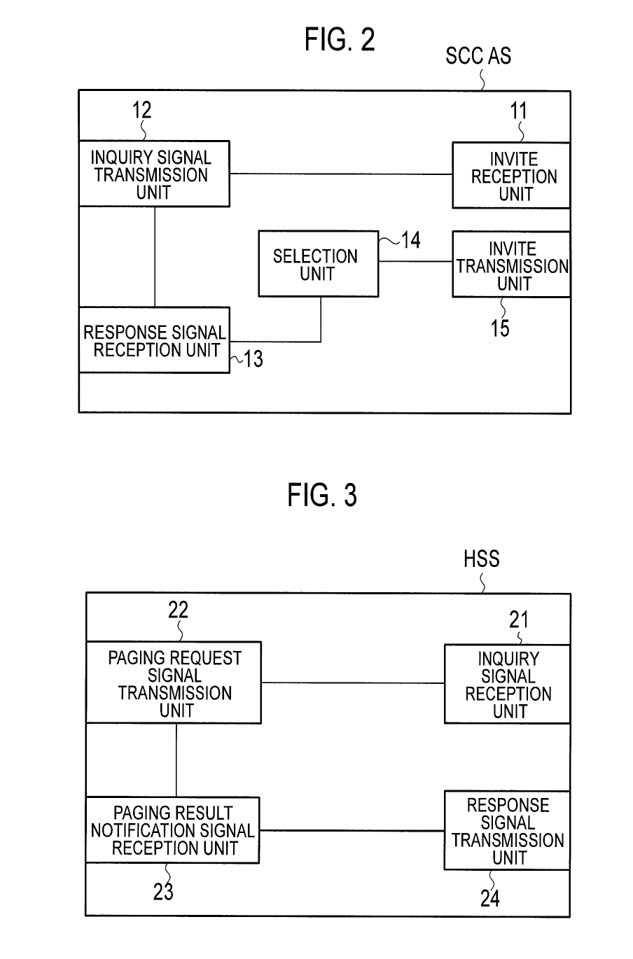

As shown in FIG. 2, the SCC-AS includes an Invite reception unit 11, an inquiry signal transmission unit 12, a response signal reception unit 13, a selection unit 14, and an Invite transmission unit 15.

The Invite reception unit 11 is configured to receive an “Invite (a terminating call signal for voice communications)” addressed to the UE transmitted from a dispatching terminal, through the S-CSCF.

The inquiry signal transmission unit 12 is configured to transmit an inquiry signal to inquire about serving area information of the UE to the HSS when the Invite reception unit 11 receives the “Invite” addressed to the UE.

The response signal reception unit 13 is configured to receive a response signal including the serving area information of the UE from the HSS. Here, the serving area information of the UE includes information on a radio access network (a current RAT for the UE) which the UE is served.

The selection unit 14 is configured to select a terminating call scheme of the “Invite” addressed to the UE, based on the information on the current RAT for the UE.

The Invite transmission unit 15 is configured to transfer the “Invite” addressed to the UE to the UTRAN/GERAN or the E-UTRAN through the S-CSCF, using the terminating call scheme selected by the selection unit 14.

As shown in FIG. 3, the HSS includes an inquiry signal reception unit 21, a paging request signal transmission unit 22, a paging result notification signal reception unit 23, and a response signal transmission unit 24.

The inquiry signal reception unit 21 is configured to receive an inquiry signal transmitted by the SCC-AS.

The paging request signal transmission unit 22 is configured to transmit a paging request signal to request at least one of the UTRAN/GERAN and E-UTRAN to transmit a paging signal when the inquiry signal reception unit 21 receives an inquiry signal.

Here, the paging request signal transmission unit 22 is configured to transmit a paging request signal to request only the UTRAN to transmit a paging signal, when, as serving area information of the UE, information indicating a state in which a location of the UE is registered only in the MSC is held.

Alternatively, the paging request signal transmission unit 22 is configured to transmit the above-mentioned paging request signal to the SGSN and the MME. The paging request signal may indicate that it is a paging signal related to the T-ADS function.

Here, the paging request signal transmission unit 22 may also be configured to transmit the above-mentioned paging request signal to the MSC, instead of the SGSN.

With the configuration, since the MSC is configured to perform calling related to an “Invite (a terminating call signal for voice communications)”, the UE has only set a CS (Circuit Switching) bearer when the UE is served by the UTRAN/GERAN, and does not have to set a PS (Packet Switching) bearer with the SGSN.

This produces an effect that calling on the UTRAN/GERAN side does not fail when the UTRAN/GERAN side cannot take over the PS bearer set in the E-UTRAN.

In addition, the configuration is similar to a processing mechanism for an existing terminating call signal for voice communications, and can produce an effect that there are a few specification changes.

In addition, in the mobile communication system according to the embodiment, when CSFB (Circuit Switching Fallback) can be performed, the paging request signal transmission unit 22 may be configured to transmit the above-mentioned paging request signal to only the MSC. In this case, a paging request signal to the MSC may represent a paging signal related to the T-ADS function.

With the configuration, according to the CSFB specification, specifically, when the UE is served by the E-UTRAN, a paging signal is transferred to the MME and calling is performed in the E-UTRAN.

However, in order to prevent the UE from switching radio from the E-UTRAN to the UTRAN/GERAN by CSFB processing, when a paging signal to be transferred from the MSC to the MME indicates that it is calling related to the T-ADS function, the MME transmits to the UE the paging signal indicating accordingly, and the UE thereby connects to the E-UTRAN without performing the CSFB.

On the other hand, when the UE is served by the UTRAN/GERAN, the paging signal is transferred to the UTRAN/GERAN through the MSC or the SGSN, and the UE sets the CS bearer.

In addition, when the ISR is valid, the signal transferred from the MSC to the MME is further transferred from the MME to the SGSN, and each of the MME and the SGSN transmits the paging signal to the E-UTRAN and the UTRAN/GERAN.

Consequently, the configuration produces an effect that it not only reduces the number of paging request signals, but also can utilize the existing CSFB procedure.

The paging result notification signal reception unit 23 is configured to receive a paging result notification signal including a paging result in the UTRAN/GERAN and E-UTRAN, from a serving device (the SGSN, the MSC, the MME, and the like) to which a paging request signal is transmitted by the paging request signal transmission unit 22.

The response signal transmission unit 24 transmits a response signal including the serving area information of the UE to the SCC-AS, when the paging result notification signal reception unit 23 receives the paging result notification signal.

Here, the response signal transmission unit 24 is configured to determine a current RAT for the UE based on a serving device which transmits a paging result notification signal including a paging result showing that connection with the UE has succeeded, generates a response signal including information on the current RAT for the UE, and transmit it to the SCC-AS.

In addition, when the response signal transmission unit does not receive a paging result notification signal indicating that connection with the UE has succeeded from the time when the paging request signal transmission unit 22 transmits a paging request signal till a predetermined period of time elapses, the response signal transmission unit 24 is configured to generate a response signal indicating an error and transmit it to the SCC-AS.

An operation of the mobile communication system according to a first embodiment of the present invention will be described hereinafter with reference to FIG. 1.

As shown in FIG. 1, in step S1001, when an SCC-AS receives an “Invite” addressed to a UE through an S-CSCF, the SCC-AS transmits an inquiry signal to inquire about serving area information of the UE (for example, information on a serving RAT, a serving MME, a serving MSC, or a serving SGSN, and the like) to an HSS in step S1002.

In step S1003, the HSS transmits a paging request signal to request at least one of an UTRAN/GERAN and an E-UTRAN to transmit a paging signal.

Here, the HSS may transmit the above-mentioned paging request signal to an SGSN and an MME, transmit the above-mentioned paging request signal to an MSC and the MME, or transmit the above-mentioned paging request signal to only the MSC.

In step S1004, a serving device (the SGSN, the MSC, the MME and the like) which receives the above-mentioned paging request signal transmits a paging signal in the UTRAN/GERAN and the E-UTRAN.

In addition, in the mobile communication system according to the embodiment, when CSFB can be performed and when the above-mentioned paging request signal is only received by the MSC, the MSC transmits a paging signal in the UTRAN/GERAN or the E-UTRAN.

Here, when the UE receives a paging signal, the UE establishes connection (RRC (Radio Resource Control) connection and the like, for example) with the RAT (the UTRAN/GERAN or the E-UTRAN, for example) which receives the paging signal, and makes a transition to a connection state.

In step S1005, the serving device which receives the above-mentioned paging request signal transmits to the HSS a paging result notification signal indicating whether or not connection with the UE has succeeded (specifically, whether or not connection has been established with the UE and whether or not the UE has made a transition to the connection state).

Here, when connection with the UE has not succeeded after transmitting the paging signal till a predetermined period of time elapses, the serving device which receives the above-mentioned paging request signal may transmit a paging result notification signal indicating accordingly or may not transmit a paging result notification signal itself to the HSS.

The HSS determines that the RAT (the UTRAN/GERAN or/and the E-UTRAN) accommodated by the serving device (the SGSN, the MSC, or the MME and the like, for example) which transmits the paging result notification signal indicating that connection with the UE has succeeded is the current RAT for the UE, and transmits to the SCC-AS a response signal including serving area information of the UE including information on the current RAT for the UE.

Note that the paging result notification signal may include information (Cell-ID and the like, for example) to identify a current cell for the UE. In such a case, the HSS may transmit a response signal including information to specify the current cell for the UE to the SCC-AS.

In step S1007, the SCC-AS selects a terminating call scheme based on information on the current RAT for the UE, and instructs the S-CSCF to transfer an “Invite” addressed to the UE to the UTRAN/GERAN or the E-UTRAN, using the terminating call scheme.

When the S-CSCF is instructed to transfer to the UTRAN/GERAN, the S-CSCF transmits “IAM” to the UE which is in a connection state in the UTRAN/GERAN, through the MGCF and the MSC, in step S1009.

On the other hand, when the S-CSCF is instructed to transfer to the UTRAN/GERAN, the S-CSCF transmits an “Invite” to the UE which is in a connection state in the E-UTRAN, through the P-CSCF and the S/P-GW, in step S2009.

According to the mobile communication system according to the first embodiment of the present invention, since a configuration may be such that the “Invite” addressed to the UE is transferred to the UTRAN/GERAN or/and the E-UTRAN with which the UE is connected after the UE is caused to make a transition to a connection state in the UTRAN/GERAN or/and the E-UTRAN by using a paging signal in response to receipt of an “Invite” addressed to the UE, the SCC-AS can correctly select a receiving domain with the T-ADS function. In addition, even when the ISR is running, similarly, the SCC-AS can correctly select a receiving domain.

### (Modification 1)

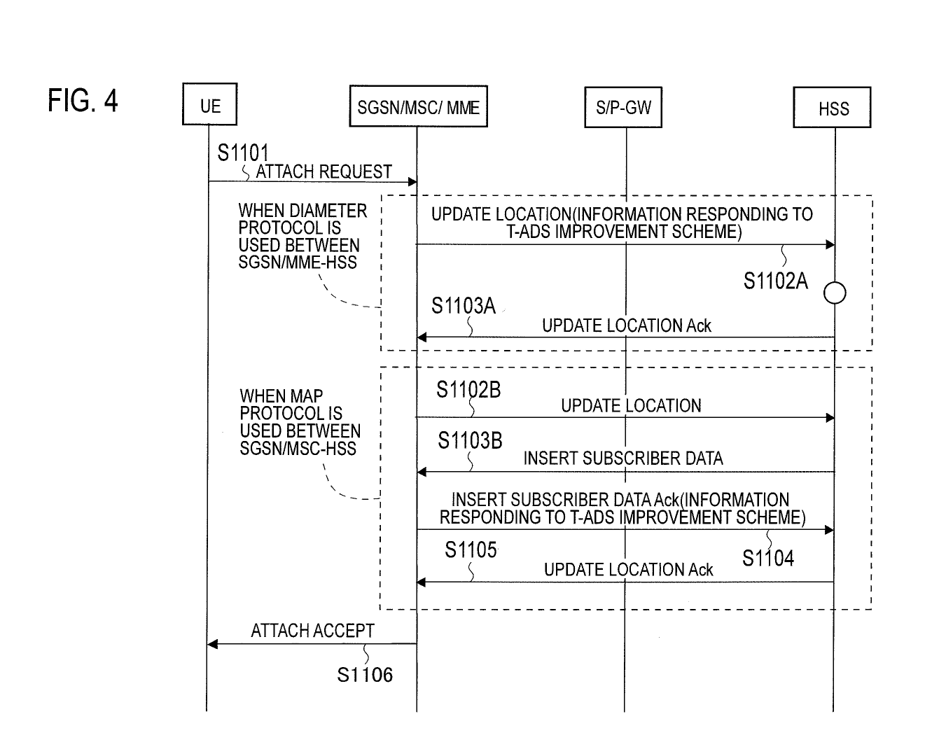

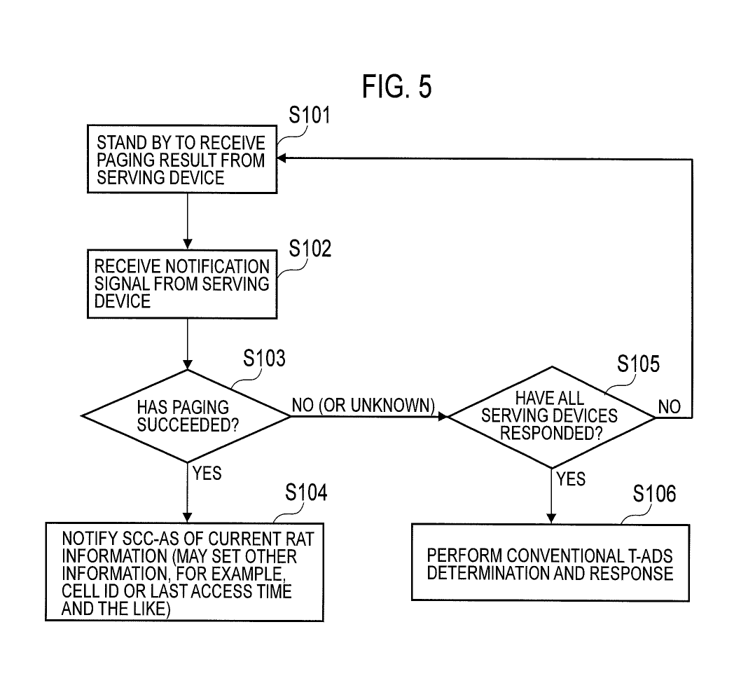

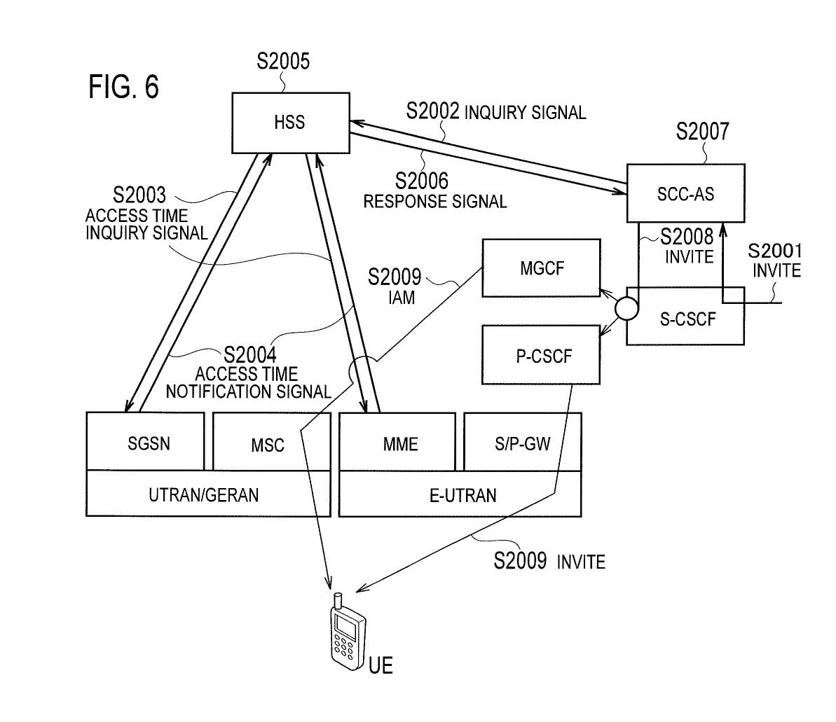

A mobile communication system according to a modification 1 of the present invention will be described with reference to FIG. 1, FIG. 4 and FIG. 5. In the following, the mobile communication system according to the modification 1 will be described, focusing on differences from the mobile communication system according to the first embodiment described above.

First, with reference to FIG. 4, a location registration process of a UE in the mobile communication system according to the modification 1 will be described.

As shown in FIG. 4, in step S1101, the UE transmits “Attach Request” to a serving device such as an SGSN/MSC/MME and the like.

When the serving device is the SGSN or the MME and a Diameter protocol is used between the serving device and the HSS, the serving device transmits to the HSS “Update Location” including “information responding to a T-ADS improvement method”.

Here, the “information responding to a T-ADS improvement method” is information indicating whether or not the serving device responds to operation of the mobile communication system (hereinafter referred to as the T-ADS improvement method) according to the first embodiment described above.

For example, the “information responding to the T-ADS improvement method” may be set as a location information element of “Feature List AVP”. In such a case, the “information responding to the T-ADS improvement method” may be set in a similar manner to an existing parameter “T-ADS Data Retrieval” set in “Feature List AVP”.

In addition, when the serving device is the SGSN or the MME, the serving device may also notify the HSS that the radio access system (the UTRAN/GERAN/E-UTRAN) it accommodates cannot provide VoIP (Voice over IP) communications.

In step S1103A, the HSS holds the capability (information indicating whether or not to respond to the T-ADS improvement method, information indicating whether or not to provide the VoIP communication, and the like, for example) of the serving device and transmits “Update Location Ack” to the serving device.

On the other hand, when the serving device is the SGSN or the MME and an MAP (Mobile Application Part) protocol is used between the serving device and the HSS, the serving device transmits to the HSS “Update Location” in step S1102B.

In step S1103B, the HSS transmits “Insert Subscriber Data” to the serving device, and the serving device transmits to the HSS “Insert Subscriber Data Ack” including the “information responding to the above-mentioned T-ADS improvement method”, in step S1104.

In step S1105, the HSS transmits “Update Location Ack” to the serving device.

In step S1106, the serving device transmits “Attach Accept” to the UE.

Note that also in registration area update process such as TAU (Tracking Area Update) process or RAU (Routing Area Update) process, operation similar to that in FIG. 4 may be performed.

In addition, in the modification 1, the process in FIG. 4 does not have to be performed.

Secondly, with reference to FIG. 1, operation at the time of an incoming call in the mobile communication system according to the modification 1 will be described, focusing on differences from the operation at the time of an incoming call in the mobile communication system according to the first embodiment described above.

In step S1002, when the HSS receives the above-mentioned inquiry signal from the SCC-AS, the HSS may determine whether to apply the T-ADS improvement method or the conventional T-ADS scheme.

Here, the HSS may make such a determination, considering the “information responding to the T-ADS improvement method”, roaming state of the UE, whether or not the VoIP communication is applied in a network which the UE is serving, whether or not the ISR (Idle-mode Signaling Reduction) is used, whether or not Combine location is registered, a subscriber profile, content of a roaming agreement, an operator policy and the like.

In step S1003, the HSS may notify the MSC of the above-mentioned paging request signal according to the procedure of “MAP-PROVIDE-SUBSCRIBER-INFO Service”.

Here, the HSS may set “enhanced T-ADS Request” to expressly notify whether or not to apply the T-ADS improvement method.

Alternatively, the HSS may set conventional “T-ADS Request”, and the MSC may determine whether or not to apply the T-ADS improvement method based on the “T-ADS Request”.

In addition, in step S1003, the HSS may notify the MME of the above-mentioned paging request signal by “Insert Subscriber Data Request”.

Here, the HSS may set “enhanced T-ADS Request” to expressly notify whether or not to apply the T-ADS improvement method.

Alternatively, the HSS may set the conventional “T-ADS Request”, and the MME may determine whether or not to apply the T-ADS improvement method, based on the “T-ADS Request”.

Note that when VoIP is not applied under the control of SGSN, the HSS does not have to notify the SGSN of the paging request signal.

In addition, the HSS may notify the SGSN of the paging request signal, and the SGSN may perform “CS Paging”. In such a case, when receiving a CS Paging signal, the UE performs connection to the MSC.

Here, in Step S1003, when information indicating that the MSC has received the above-mentioned paging request signal (or a serving area information notification request signal) and that the HSS has requested the SGSN to perform CS paging is set, in step S1004, the MSC may stand by for connection from the UE for a predetermined period of time without performing Paging. Here, when there is no connection from UE within the predetermined period of time, in step S1005, the MSC notifies the HSS that the UE did not connect.

In step S1004, SGs-Association is set with the MME, the MSC transmits the above-mentioned paging signal to the UTRAN/GERAN under the control, and does not instruct the MME to transmit the above-mentioned paging signal.

On the other hand, in step S1004, when Gs-Association is set with the SGSN, the MSC instructs the SGSN to transmit the above paging signal. The signal may clearly specify that it is calling from the circuit switch.

In addition, in step S1004, the MME transmits the above-mentioned paging signal only when the VoIP communication is provided in the UE serving area.

Note that when the MME is aware that a context of the UE is no longer valid, the MME does not have to transmit the above-mentioned paging signal. In such a case, in step S1005, the MME notifies the HSS accordingly by the above-mentioned paging result notification signal.

In step S1005, the serving device may also notify whether or not to apply the T-ADS improvement method, a transmission result of a paging signal (which may include whether or not there is connection of the UE), state of UE, location information such as a cell ID of the cell to which the UE connects, etc., a type of RAT which transmits a paging signal, and the like.

Thirdly, with reference to FIG. 5, operation of the HSS according to the modification 1 will be described.

As shown in FIG. 5, in step S101, the HSS is standing by for receipt of a paging result notification signal from a serving device. In step S102, when the serving device receives the paging result notification signal, the HSS determines based on the paging result notification signal whether or not calling Paging) by the serving device has succeeded (specifically, whether or not the UE has connected to the serving device) in step S103.

When the determination is “Yes” in step S103, the HSS transmits a response signal including the serving area information of the UE to the SCC-AS in step S104 (see step S1006 in FIG. 1).

Here, the HSS may also set the above-mentioned paging result notification signal to the SCC-AS in the response signal, or may set the UE serving information it determines by itself.

Note that when the above paging result notification signal is set to the response signal, the SCC-AS may determine the serving area information of the UE.

In addition, the HSS may set a cell ID or last access time and the like for the cell to which the UE connects as the response signal.

When the determination is “No” in step S103, or when it is unknown whether paging by the serving device has succeeded or not (specifically, whether or not the UE has connected to the serving device), in step S105, the HSS determines whether or not it has received paging result notification signals from all serving devices.

When the determination is “Yes” in step S105, the HSS transmits a response signal based on the conventional T-ADS scheme to the SCC-AS.

When the determination is “No” in step S105, the operation returns to step S101.

The characteristics of the embodiment described above may be expressed as follows:

A first characteristic of the embodiment is a mobile communication method in a mobile communication system including a UTRAN/GERAN (a radio access network of a first communication scheme) and an E-UTRAN (a radio access network of a second communication scheme), the method being summarized in that the method includes: a step A of causing an SCC-AS (a predetermined server) to transmit an inquiry signal to inquire about serving area information of a UE (a mobile station) to an HSS (a subscriber management server) when the predetermined server receives an “Invite (a terminating call signal for voice communications)” addressed to the UE; a step B of causing the HSS to transmit a paging request signal to request at least one of the UTRAN/GERAN and the E-UTRAN to transmit a paging signal; a step C of causing the HSS to determine a radio access network which the UE is served, in response to a paging result notification signal including a paging result in the UTRAN/GERAN and the E-TRAN; a step D of causing the HSS to transmit the serving area information of the UE including information on the radio access network which the UE is served to the SCC-AS; and a step E of causing the SCC-AS to transfer the “Invite” addressed to the UE, to the UTRAN/GERAN or the E-UTRAN, using a terminating call scheme selected based on the serving area information of the UE.

In the first characteristic of the embodiment, the HSS may transmit the above paging request signal to an SGSN (a packet switch of the first communication scheme) and an MME (a mobility management node of the second communication scheme).

In the first characteristic of the embodiment, in the step B, the HSS may transmit the above-mentioned paging request signal to an MSC (a circuit switch of the first communication scheme) and the MME.

In the first characteristic of the embodiment, in the mobile communication system mentioned above, CSFB can be performed (a mobile station camping on in a radio access network of the second communication scheme can start voice communications using circuit switch service in a radio access network of the first communication scheme), and in the step B, the HSS may transmit the above-mentioned paging request signal to only the MSC.

In the first characteristic of the embodiment, the method may include the steps of: causing the MSC to transmit a call request signal indicative of information indicating that it is calling related to T-ADS function (information indicating that it is a predetermined terminating call signal) to the MME; causing the MME to transmit a paging signal including information indicating that it is calling related to the T-ADS function; and causing the UE not to perform CSFB when the paging signal includes the information indicating that it is calling related to the T-ADS function.

In the first characteristic of the embodiment, a paging result notification signal may include information (Cell-ID) to identify a cell which the UE is served.

In the first characteristic of the embodiment, a paging result notification signal may include information (Cell-ID) to identify a cell which the UE is served.

A second characteristic of the embodiment is an HSS to be used in a mobile communication system including a UTRAN/GERAN and an E-UTRAN, the HSS being summarized in that the HSS includes a paging request signal transmission unit 22 configured to transmit a paging request signal for requesting at least one of the UTRAN/GERAN and the E-UTRAN to transmit a paging signal, in response to an inquiry signal received from an SCC-AS (a predetermined server); and a response signal transmission unit 24 configured to transmit serving area information of the UE including information on a radio access network which the UE is served to the SCC-AS, in response to a paging result notification signal including a paging result in the UTRAN/GERAN and the E-UTRAN.

In the second characteristic of the embodiment, the paging request signal transmission unit 22 may also be configured to transmit the above-mentioned paging request signal to the SGSN and the MME.

In the second characteristic of the embodiment, the paging request signal transmission unit 22 may also be configured to transmit the above-mentioned paging request signal to the MSC and the MME.

In the second characteristic of the embodiment, in the mobile communication system described above, CSFB may be capable of being performed, and the paging request signal transmission unit 22 may also be configured to transmit the above-mentioned paging request signal to only the MSC.

In the second characteristic of the embodiment, a paging result notification signal may include information (Cell-ID) to identify a cell which the UE is served.

A third characteristic of the embodiment is an SCC-AS to be used in a mobile communication system including a UTRAN/GERAN and a E-UTRAN, the SCC-AS being summarized in that the SCC-AS includes an inquiry signal transmission unit 12 configured to transmit an inquiry signal to inquire about serving area information of the UE to an HSS when an “Invite” addressed to the UE is received; a response signal reception unit 13 configured to receive from the HSS the serving area information of the UE including information on a radio access network which the UE is served; and an Invite transmission unit 15 configured to transfer the “Invite” addressed to the UE to the UTRAN/GERAN or the E-UTRAN using a terminating call scheme selected based on the serving area information of the UE.

Note that operations of the UE, the RNC/BSS, the eNB, the SGSN, the MSC, the MME, the S/P-GW, the HSS, the MGCF, the P-CSCF, the S-CSCF, the SCC-AS described above may be implemented by hardware, a software module to be performed by a processor, or a combination of both.

The software module may be provided in a storage medium of any form such as a RAM (Random Access Memory), a flash memory, a ROM (Read Only Memory), an EPROM (Erasable Programmable ROM), an EEPROM (Electronically Erasable and Programmable ROM), a register, a hard disk, a removable disk, or a CD-ROM.

Such a storage medium is connected to a processor so that the processor can write and read information to/from the storage medium. In addition, the storage medium may be integrated in a processor. In addition, the storage medium may be provided in an ASIC. The ASIC may be provided in a UE, an RNC/BSS, an eNB, an SGSN, an MSC, an MME, an S/P-GW, an HSS, an MGCF, a P-CSCF, an S-CSCF, an SCC-AS, and the like. In addition, the storage medium and the processor may be provided as a discrete component in the UE, the RNC/BSS, the eNB, the SGSN, the MSC, the MME, the S/P-GW, the HSS, the MGCF, the P-CSCF, the S-CSCF, the SCC-A and the like.

As described above, although the present invention has been described in detail by using the embodiments described above, it is apparent to those skilled in the art that the present invention shall not be limited to the embodiments described in the specification. The present invention can be carried out as a modification or an alteration without deviating from the intent and scope of the present invention defined by a description of the Claims. Therefore, the description of the specification is intended to provide an exemplary description and does not have any limiting sense to the present invention.

### EXPLANATION OF THE REFERENCE NUMERALS

SCC-AS . . . Application server
11 . . . Invite reception unit
12 . . . Inquiry signal reception unit
13 . . . Response signal reception unit
14 . . . Selection unit
15 . . . Invite transmission unit
HSS . . . Subscriber management server
21 . . . Inquiry signal reception unit
22 . . . Paging request signal transmission unit
23 . . . Paging result notification signal reception unit
24 . . . Response signal transmission unit

1. A mobile communication method in a mobile communication system including a radio access network of a first communication scheme and a radio access network of a second communication scheme, the mobile communication method comprising:
a step A of causing a predetermined server to transmit an inquiry signal to inquire about serving area information of a mobile station to a subscriber management server when the predetermined server receives a terminating call signal for voice communications addressed to the mobile station;
a step B of causing the subscriber management server to transmit a paging request signal to request at least one of the radio access network of the first communication scheme and the radio access network of the second communication scheme to transmit a paging signal according to an inquiry signal received from the predetermined server;
a step C of causing the subscriber management server to determine a radio access network which the mobile station is served, in response to a paging result notification signal including a paging result in the radio access network of the first communication scheme and the radio access network of the second communication scheme;
a step D of causing the subscriber management server to transmit the serving area information of the mobile station including information on the radio access network which the mobile station is served to the predetermined server; and
a step E of causing the predetermined server to transfer the terminating call signal for voice communications addressed to the mobile station, to the radio access network of the first communication scheme or the radio access network of the second communication scheme, using a terminating call scheme selected based on the serving area information of the mobile station.

2. The mobile communication method according to claim 1, wherein the first communication scheme supports circuit switch communication and packet switch communication, and the second communication scheme supports only the packet switch communication, and
in the step B, the subscriber management server transmits the paging request signal to both of a packet switch of the first communication scheme and a mobility management node of the second communication scheme.

3. The mobile communication method according to claim 1, wherein the first communication scheme supports circuit switch communication and packet switch communication, and the second communication scheme supports only the packet switch communication, and
in the step B, the subscriber management server transmits the paging request signal to both of a circuit switch of the first communication scheme and a mobility management node of the second communication scheme.

4. The mobile communication method according to claim 1, wherein the first communication scheme supports circuit switch communication and packet switch communication, and the second communication scheme supports only the packet switch communication, and
in the mobile communication system, the mobile station camping on in the radio access network of the second communication scheme can start voice communications using a circuit switch service in the radio access network of the first communication scheme, and
in the step B, the subscriber management server transmits the paging request signal to only a circuit switch of the first communication scheme.

5. The mobile communication method according to claim 4, comprising the steps of:
causing the circuit switch of the first communication scheme to transmit the paging request signal including information that it is a predetermined terminating call signal to a mobility management node of the second communication scheme;
causing the mobility management node of the second communication scheme to transmit the paging signal including the information that it is the predetermined terminating call signal; and
causing the mobile station not to perform voice communications using the circuit switch service in the radio access network of the first communication scheme when the paging signal includes the information that it is the predetermined terminating call signal.

6. The mobile communication method according to claim 1, wherein the paging result notification signal includes information to identify a cell which the mobile station is served.

7. A subscriber management server to be used in a mobile communication system including a radio access network of a first communication scheme and a radio access network of a second communication scheme, the subscriber management server comprising:
a paging request signal transmission unit configured to transmit a paging request signal for requesting at least one of the radio access network of the first communication scheme and the radio access network of the second communication scheme to transmit a paging request signal, in response to an inquiry signal received from a predetermined server; and
a response signal transmission unit configured to transmit serving area information of a mobile station including information on a radio access network which the mobile station is served to the predetermined server, in response to a paging result notification signal including a paging result in the radio access network of the first communication scheme and the radio access network of the second communication scheme.

8. The subscriber management server according to claim 7, wherein the first communication scheme supports circuit switch communication and packet switch communication, and the second communication scheme supports only the packet switch communication, and
the paging request signal transmission unit is configured to transmit the paging request signal to both of a packet switch of the first communication scheme and a mobility management node of the second communication scheme.

9. The subscriber management server according to claim 7, wherein the first communication scheme supports circuit switch communication and packet switch communication, and the second communication scheme supports only the packet switch communication, and
the paging request signal transmission unit is configured to transmit the paging request signal to both of a circuit switch of the first communication scheme and a mobility management node of the second communication scheme.

10. The subscriber management server according to claim 7, wherein the first communication scheme supports circuit switch communication and packet switch communication, and the second communication scheme supports only the packet switch communication,
in the mobile communication system, the mobile station camping on in the radio access network of the second communication scheme can start voice communications using a circuit switch service in the radio access network of the first communication scheme, and
the paging request signal transmission unit is configured to transmit the paging request signal to only a circuit switch of the first communication scheme.

11. The subscriber management server according to claim 7, wherein the paging result notification signal includes information to identify a cell which the mobile station is served.

12. A server to be used in a mobile communication system including a radio access network of a first communication scheme and a radio access network of a second communication scheme, the server comprising:
an inquiry signal transmission unit configured to transmit an inquiry signal to inquire about serving area information of a mobile station to a subscriber management server when receiving a terminating call signal for voice communications addressed to the mobile station;
a response signal reception unit configured to receive from the subscriber management server the serving area information of the mobile station including information on a radio access network which the mobile station is served; and
a terminating call signal transmission unit configured to transfer the terminating call signal for voice communications addressed to the mobile station to the radio access network of the first communication scheme or the radio access network of the second communication scheme using a terminating call scheme selected based on the serving area information of the mobile station.

13. The mobile communication method according to claim 2, wherein the paging result notification signal includes information to identify a cell which the mobile station is served.

14. The mobile communication method according to claim 3, wherein the paging result notification signal includes information to identify a cell which the mobile station is served.

15. The mobile communication method according to claim 4, wherein the paging result notification signal includes information to identify a cell which the mobile station is served.

16. The mobile communication method according to claim 5, wherein the paging result notification signal includes information to identify a cell which the mobile station is served.

17. The subscriber management server according to claim 8, wherein the paging result notification signal includes information to identify a cell which the mobile station is served.

18. The subscriber management server according to claim 9, wherein the paging result notification signal includes information to identify a cell which the mobile station is served.

19. The subscriber management server according to claim 10, wherein the paging result notification signal includes information to identify a cell which the mobile station is served.
